(19) United States
(12) Patent Application Publication
(10) Pub. No.: US 2026/0332276 A1
(43) Pub. Date: Oct. 22, 2026

(54) COMMUNICATION METHOD AND APPARATUS

(71) Applicant: HUAWEI TECHNOLOGIES CO., LTD., Shenzhen (CN)

(72) Inventors: Xi Zhang, Beijing (CN); Xiaoyan Bi, Shanghai (CN); Jianglei Ma, Ottawa (CA); Wen Tong, Ottawa (CA)

(73) Assignee: HUAWEI TECHNOLOGIES CO., LTD., Shenzhen (CN)

(21) Appl. No.: 19/711,465

(22) Filed: Jun. 17, 2026

Related U.S. Application Data
(63) Continuation of application No. PCT/CN2024/137140, filed on Dec. 5, 2024.

(30) Foreign Application Priority Data
Dec. 18, 2023 (CN) 202311751848.3

(51) Int. Cl. H04B 17/318; H04L 43/0817

(52) U.S. Cl. CPC H04B 17/318; H04L 43/0817

(57) ABSTRACT

A communication method includes: a network device sends first information, where the first information indicates a first threshold and a second threshold, and a terminal device sends N measurement results in M measurement results. The M measurement results are results obtained by measuring reference signals received through M measurement resources. The N measurement results include a first measurement result, and the first measurement result has a maximum signal strength among the M measurement results. The signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold. The terminal device reports a measurement result based on the first threshold and the second threshold.

### CROSS-REFERENCE TO RELATED APPLICATIONS

This application is a continuation of International Application No. PCT/CN2024/137140, filed on Dec. 5, 2024, which claims priority to Chinese Patent Application No. 202311751848.3, filed on Dec. 18, 2023. The disclosures of the aforementioned applications are hereby incorporated by reference in their entireties.

### TECHNICAL FIELD

This application relates to the field of communication technologies, and in particular, to a communication method and apparatus.

### BACKGROUND

To improve coverage and reduce interference, a beamforming technology is introduced. Based on the beamforming technology, a device may send signals through a plurality of beams. In a possible scenario, multi-beam spatial division transmission is supported, that is, multi-beam multi-user (MU) multiplexing/transmission is supported. The multi-beam MU transmission may also be understood as that a transmit end may simultaneously communicate with a plurality of receive ends through a plurality of beams.

If user pairs for the multi-beam MU transmission are inappropriately selected, interference may be caused between the user pairs, resulting in communication exceptions. How to determine user pairs that can perform multi-beam MU transmission is an urgent problem to be resolved.

### SUMMARY

Embodiments of this application provide a communication method and apparatus, to determine user pairs that can perform multi-beam MU transmission, and reduce communication exceptions.

To achieve the foregoing objectives, the following technical solutions are used in embodiments of this application.

According to a first aspect, an embodiment of this application provides a communication method, and the method may be performed by a first communication apparatus. The first communication apparatus may be a combined device, component, or the like configured to implement a function of a terminal device. For example, the first communication apparatus is a terminal device, or the first communication apparatus is a unit/module, a circuit, a chip, or the like inside a terminal device. The following describes, by using an example in which the first communication apparatus is the terminal device, the method provided in the first aspect.

The communication method includes: The terminal device receives first information, where the first information indicates a first threshold and a second threshold; and the terminal device sends N measurement results in M measurement results. The M measurement results are results obtained by measuring reference signals received through M measurement resources, and one measurement resource corresponds to one reference signal. The N measurement results include a first measurement result, and the first measurement result has a maximum signal strength among the M measurement results. Both M and N are integers greater than 1. The signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold.

The first threshold may be a signal strength threshold. If a signal strength corresponding to a measurement result of a resource is greater than the first threshold, it may be considered that communication quality of the resource is good. If a difference between signal strengths corresponding to measurement results of two resources is large, it may be considered that interference between the two resources is low, or even there is no interference. In the method, the terminal device reports a measurement result to a network device based on the first threshold and the second threshold. For example, the terminal device reports, to the network device, the first measurement result in which a signal strength is greater than or equal to the first threshold, as well as N−1 measurement results for which differences between signal strengths of the N−1 measurement results and the signal strength corresponding to the first measurement result are greater than or equal to the second threshold. In this way, resources corresponding to the first measurement result and the N−1 measurement results are used as candidate resources (also referred to as candidate serving resources) for MU pairing, so that the network device can clearly determine a resource with good communication quality and a resource with low interference to the resource. In this way, the network device can determine a plurality of more suitable terminal devices to perform MU transmission, thereby reducing communication exceptions. In addition, in comparison with a case in which a terminal device reports measurement results of all resources, in this case, an amount of data reported by each terminal device can be reduced, and resource overheads can be reduced.

In an implementation, the N measurement results are the first measurement result and a second measurement result. The second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold, where T is a positive integer.

In the method, the N−1 measurement results are a second measurement result, that is, a measurement result in which a signal strength is the maximum among the T measurement results for which differences between signal strengths of the T measurement results and the signal strength corresponding to the first measurement result are greater than or equal to the second threshold. Using resource corresponding to the second measurement result as a candidate serving resource of the terminal device can increase a probability of MU pairing in comparison with using only the first measurement result as the candidate serving resource of the terminal device.

In an implementation, the first information further indicates one or more of the following: the M measurement resources, a value of N, or a first resource set, where the first resource set includes the M measurement resources.

In an implementation, the method further includes: The terminal device receives second information, where the second information indicates a first resource set and/or a value of N, and the first resource set includes the M measurement resources.

According to a second aspect, an embodiment of this application provides a communication method, and the method may be performed by a first communication apparatus. The first communication apparatus may be a combined device, component, or the like configured to implement a function of a terminal device. For example, the first communication apparatus is a terminal device, or the first communication apparatus is a unit/module, a circuit, a chip, or the like inside a terminal device. The following describes, by using an example in which the first communication apparatus is the terminal device, the method provided in the second aspect.

The communication method includes: The terminal device receives first information, where the first information indicates a first threshold; and the terminal device sends N measurement results in M measurement results. The M measurement results are results obtained by measuring reference signals received through M measurement resources, and one measurement resource corresponds to one reference signal. The N measurement results include a first measurement result. A signal strength corresponding to the first measurement result is less than or equal to the first threshold, and the N measurement results are first N measurement results obtained by sorting the M measurement results in descending order of signal strengths. Both M and N are integers greater than 1.

The first threshold may be a signal strength threshold. In the method, when the signal strength corresponding to the first measurement result is less than or equal to the first threshold, the terminal device still reports the N measurement results with relatively large signal strengths to a network device, so that the network device can determine a plurality of suitable terminal devices to perform MU transmission, thereby reducing communication exceptions.

In an implementation, the first information further indicates one or more of the following: the M measurement resources, a value of N, or a first resource set, where the first resource set includes the M measurement resources.

In an implementation, the method further includes: The terminal device receives second information, where the second information indicates a first resource set and/or a value of N, and the first resource set includes the M measurement resources.

According to a third aspect, an embodiment of this application provides a communication method, and the method may be performed by a first communication apparatus. The first communication apparatus may be a combined device, component, or the like configured to implement a function of a terminal device. For example, the first communication apparatus is a terminal device, or the first communication apparatus is a unit/module, a circuit, a chip, or the like inside a terminal device. The following describes, by using an example in which the first communication apparatus is the terminal device, the method provided in the third aspect.

The communication method includes: The terminal device receives third information, and sends fourth information. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is greater than or equal to the first threshold, the fourth information includes S values, an i^{th} value in the S values is a difference between an i^{th} measurement result in S measurement results and the first measurement result, and the S measurement results belong to the Q measurement results.

The first threshold may be a signal strength threshold. In the method, when the signal strength corresponding to the first measurement result is greater than or equal to the first threshold, the terminal device reports the first measurement result and the S values to a network device, and the network device performs MU pairing based on the S values. The S values correspond to measurement results of the S resources (namely, interference resources). Therefore, the network device may determine, based on the S values, a resource that causes interference to a serving beam, and further determine a resource that is not suitable for MU transmission. In comparison with a case in which the network device performs MU pairing by using a serving beam of each terminal device as a candidate resource, in this case, interference between a plurality of determined users for MU transmission can be reduced, and communication exceptions can be reduced. In addition, in comparison with a case in which a terminal device reports measurement results of all resources, in this case, a terminal device reports the first measurement result and the S values, so that an amount of data reported by each terminal device can be reduced, and resource overheads can be reduced.

In an implementation, S is less than Q−1, the Q measurement results further include R measurement results, and R is a difference between Q−1 and S. If there are a small quantity of interference resources, the terminal device may further report measurement results of more measurement resources, so that the network device obtains the measurement results of the more resources, to determine more suitable MU pairing.

In an implementation, the R measurement results are first R measurement results obtained by sorting the P measurement results except the first measurement result in descending order of signal strengths. In this solution, the terminal device preferentially reports the R measurement results with relatively large signal strengths. In this way, using the R measurement results as candidate service resources of the terminal device can increase a probability of MU pairing in comparison with using only the first measurement result as a candidate serving resource of the terminal device.

In an implementation, when the second resource set is invalid, the Q measurement results are first Q measurement results obtained by sorting the P measurement results in descending order of signal strengths. If the second resource set is invalid, the terminal device reports, by default, the first Q measurement results obtained by sorting the P measurement results in descending order of signal strengths. In this way, the network device uses resources corresponding to the Q measurement results as candidate service resources, so that relatively good communication quality can be ensured.

In an implementation, the third information further indicates one or more of the following: the P measurement resources, a value of Q, or a first resource set, where the first resource set includes the P measurement resources.

In an implementation, the method further includes: The terminal device receives fifth information, where the fifth information indicates a first resource set and/or a value of Q, and the first resource set includes the P measurement resources.

According to a fourth aspect, an embodiment of this application provides a communication method, and the method may be performed by a first communication apparatus. The first communication apparatus may be a combined device, component, or the like configured to implement a function of a terminal device. For example, the first communication apparatus is a terminal device, or the first communication apparatus is a unit/module, a circuit, a chip, or the like inside a terminal device. The following describes, by using an example in which the first communication apparatus is the terminal device, the method provided in the fourth aspect.

The communication method includes: The terminal device receives third information, and sends fourth information. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is less than or equal to the first threshold, the fourth information includes the Q measurement results, and the Q measurement results are first Q measurement results obtained by sorting the P measurement results in descending order of signal strengths.

The first threshold may be a signal strength threshold. In the method, when the signal strength corresponding to the first measurement result is less than or equal to the first threshold, the terminal device still reports the Q measurement results with large signal strengths to a network device, so that the network device can determine a plurality of suitable terminal devices to perform MU transmission, thereby reducing communication exceptions.

In an implementation, the third information further indicates one or more of the following: the P measurement resources, a value of Q, or a first resource set, where the first resource set includes the P measurement resources.

In an implementation, the method further includes: The terminal device receives fifth information, where the fifth information indicates a first resource set and/or a value of Q, and the first resource set includes the P measurement resources.

According to a fifth aspect, an embodiment of this application provides a communication method, and the method may be performed by a second communication apparatus. The second communication apparatus may be a combined device, component, or the like configured to implement a function of a network device. For example, the second communication apparatus is a network device, or the second communication apparatus is a unit/module, a circuit, a chip, or the like inside a network device. The following describes, by using an example in which the second communication apparatus is the network device, the method provided in the fifth aspect.

The communication method includes: The network device sends first information, and receives N measurement results. The first information indicates a first threshold and a second threshold. The N measurement results belong to M measurement results, the M measurement results are results obtained by measuring reference signals received through M measurement resources, and one measurement resource corresponds to one reference signal. The N measurement results include a first measurement result, and the first measurement result has a maximum signal strength among the M measurement results. Both M and N are integers greater than 1. The signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold.

In an implementation, the N measurement results are the first measurement result and a second measurement result. The second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold.

In an implementation, the first information further indicates one or more of the following: the M measurement resources, a value of N, or a first resource set, where the first resource set includes the M measurement resources.

In an implementation, the method further includes: The network device sends second information, where the second information indicates a first resource set and/or a value of N, and the first resource set includes the M measurement resources.

For beneficial effect of the fifth aspect and the implementations of the fifth aspect, refer to beneficial effect of the first aspect and the implementations of the first aspect. Details are not described herein again.

According to a sixth aspect, an embodiment of this application provides a communication method, and the method may be performed by a second communication apparatus. The second communication apparatus may be a combined device, component, or the like configured to implement a function of a network device. For example, the second communication apparatus is a network device, or the second communication apparatus is a unit/module, a circuit, a chip, or the like inside a network device. The following describes, by using an example in which the second communication apparatus is the network device, the method provided in the sixth aspect.

The communication method includes: The network device sends first information, and receives N measurement results. The first information indicates a first threshold. The N measurement results belong to M measurement results, the M measurement results are results obtained by measuring reference signals received through M measurement resources, and one measurement resource corresponds to one reference signal. The N measurement results include a first measurement result. A signal strength corresponding to the first measurement result is less than or equal to the first threshold, and the N measurement results are first N measurement results obtained by sorting the M measurement results in descending order of signal strengths. Both M and N are integers greater than 1.

In an implementation, the first information further indicates one or more of the following: the M measurement resources, a value of N, or a first resource set, where the first resource set includes the M measurement resources.

In an implementation, the method further includes: The network device sends second information, where the second information indicates a first resource set and/or a value of N, and the first resource set includes the M measurement resources.

For beneficial effect of the sixth aspect and the implementations of the sixth aspect, refer to beneficial effect of the second aspect and the implementations of the second aspect. Details are not described herein again.

According to a seventh aspect, an embodiment of this application provides a communication method, and the method may be performed by a second communication apparatus. The second communication apparatus may be a combined device, component, or the like configured to implement a function of a network device. For example, the second communication apparatus is a network device, or the second communication apparatus is a unit/module, a circuit, a chip, or the like inside a network device. The following describes, by using an example in which the second communication apparatus is the network device, the method provided in the seventh aspect.

The communication method includes: The network device sends third information, and receives fourth information. The third information indicates a first threshold and a second resource set, the second resource set includes S resources for interference measurement, and S is an integer greater than or equal to 1. The fourth information indicates Q measurement results, the Q measurement results belong to P measurement results, the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is greater than or equal to the first threshold, the fourth information includes S values, an i^{th} value in the S values is a difference between an i^{th} measurement result in S measurement results and the first measurement result, and the S measurement results belong to the Q measurement results.

In an implementation, S is less than Q−1, the Q measurement results further include R measurement results, and R is a difference between Q−1 and S.

In an implementation, the R measurement results are first R measurement results obtained by sorting the P measurement results except the first measurement result in descending order of signal strengths.

In an implementation, when the second resource set is invalid, the Q measurement results are first Q measurement results obtained by sorting the P measurement results in descending order of signal strengths.

In an implementation, the third information further indicates one or more of the following: the P measurement resources, a value of Q, or a first resource set, where the first resource set includes the P measurement resources.

In an implementation, the method further includes: The network device sends fifth information, where the fifth information indicates a first resource set and/or a value of Q, and the first resource set includes the P measurement resources.

For beneficial effect of the seventh aspect and the implementations of the seventh aspect, refer to beneficial effect of the third aspect and the implementations of the third aspect. Details are not described herein again.

According to an eighth aspect, an embodiment of this application provides a communication method, and the method may be performed by a second communication apparatus. The second communication apparatus may be a combined device, component, or the like configured to implement a function of a network device. For example, the second communication apparatus is a network device, or the second communication apparatus is a unit/module, a circuit, a chip, or the like inside a network device. The following describes, by using an example in which the second communication apparatus is the network device, the method provided in the eighth aspect.

The communication method includes: The network device sends third information, and receives fourth information. The third information indicates a first threshold and a second resource set, the second resource set includes S resources for interference measurement, and S is an integer greater than or equal to 1. The fourth information indicates Q measurement results, the Q measurement results belong to P measurement results, the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is less than or equal to the first threshold, the fourth information includes the Q measurement results, and the Q measurement results are first Q measurement results obtained by sorting the P measurement results in descending order of signal strengths.

In an implementation, the third information further indicates one or more of the following: the P measurement resources, a value of Q, or a first resource set, where the first resource set includes the P measurement resources.

In an implementation, the method further includes: The network device sends fifth information, where the fifth information indicates a first resource set and/or a value of Q, and the first resource set includes the P measurement resources.

For beneficial effect of the eighth aspect and the implementations of the eighth aspect, refer to beneficial effect of the fourth aspect and the implementations of the fourth aspect. Details are not described herein again.

According to a ninth aspect, an embodiment of this application provides a communication method, and the method may be performed by a first communication apparatus and a second communication apparatus. The first communication apparatus may be a terminal device, or the first communication apparatus is a component configured to implement a function of a terminal device. For example, the first communication apparatus is a unit/module, a circuit, a chip, or the like inside the terminal device. The second communication apparatus may be a network device, or the second communication apparatus is a component configured to implement a function of a network device. For example, the second communication apparatus is a unit/module, a circuit, a chip, or the like inside the network device.

For example, the communication method includes: The network device sends first information to the terminal device, and the terminal device sends N measurement results in M measurement results to the network device. The first information indicates a first threshold and a second threshold. The M measurement results are results obtained by measuring reference signals received through M measurement resources, and one measurement resource corresponds to one reference signal. The N measurement results include a first measurement result, and the first measurement result has a maximum signal strength among the M measurement results. Both M and N are integers greater than 1. When the signal strength corresponding to the first measurement result is greater than or equal to the first threshold, a difference between a signal strength corresponding to each of remaining N−1 measurement results in the N measurement results and the signal strength corresponding to the first measurement result is greater than or equal to the second threshold.

For another example, the communication method includes: The network device sends third information to the terminal device, and the terminal device sends fourth information to the network device. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is greater than or equal to the first threshold, the fourth information includes S values, an i^{th} value in the S values is a difference between an i^{th} measurement result in S measurement results and the first measurement result, and the S measurement results belong to the Q measurement results.

For beneficial effect of the ninth aspect, refer to beneficial effect of the first aspect to the fourth aspect and the implementations of the first aspect to the fourth aspect. Details are not described herein again.

According to a tenth aspect, an embodiment of this application provides a communication apparatus. The communication apparatus has a function of implementing a behavior in the method example according to any one of the first aspect to the eighth aspect. For beneficial effect, refer to related descriptions of the first aspect to the fourth aspect. Details are not described herein again. For example, the communication apparatus may be the terminal device according to any one of the first aspect to the fourth aspect, or the communication apparatus may be an apparatus that can support the terminal device in implementing a function required by the method provided in any one of the first aspect to the fourth aspect. For example, the communication apparatus may be a chip or a chip system in the terminal device. For another example, the communication apparatus may be the network device according to any one of the fifth aspect to the eighth aspect, or the communication apparatus may be an apparatus that can support the network device in implementing a function required by the method provided in any one of the fifth aspect to the eighth aspect. For example, the communication apparatus may be a chip or a chip system in the network device.

In a possible design, the communication apparatus includes a baseband apparatus and a radio frequency apparatus.

In a possible design, the communication apparatus includes a corresponding means (means) or module configured to perform the method according to any one of the first aspect to the eighth aspect. For example, the communication apparatus includes a processing unit (sometimes also referred to as a processing module or a processor) and/or a transceiver unit (sometimes also referred to as a transceiver module or a transceiver). The transceiver unit can implement a sending function and a receiving function. When the transceiver unit implements the sending function, the transceiver unit may be referred to as a sending unit (sometimes also referred to as a sending module). When the transceiver unit implements the receiving function, the transceiver unit may be referred to as a receiving unit (sometimes also referred to as a receiving module). The sending unit and the receiving unit may be a same functional unit, the functional unit is referred to as a transceiver unit, and the functional unit can implement the sending function and the receiving function. Alternatively, the sending unit and the receiving unit may be different functional units, and the transceiver unit is a general term for these functional units. These units (modules) may perform corresponding functions in the method example according to any one of the first aspect to the eighth aspect. For details, refer to the detailed descriptions in the method example. Details are not described herein.

According to an eleventh aspect, an embodiment of this application provides a communication apparatus. The communication apparatus may be the communication apparatus according to the tenth aspect of the foregoing embodiments, or may be a chip or a chip system disposed in the communication apparatus according to the tenth aspect. The communication apparatus includes a communication interface and a processor, and optionally, further includes a memory. The memory is configured to store a computer program, instructions, or data, and the processor is coupled to the memory and the communication interface. When the processor reads the computer program, the instructions, or the data, the communication apparatus is enabled to perform the method performed by the terminal device in the foregoing method embodiments. For example, the communication apparatus may be the terminal device or a functional module in the terminal device, for example, a baseband chip and a radio frequency chip. Alternatively, when the processor reads the computer program, the instructions, or the data, the communication apparatus is enabled to perform the method performed by the network device in the foregoing method embodiments. For example, the communication apparatus may be the network device or a functional module in the network device, for example, a baseband chip and a radio frequency chip.

According to a twelfth aspect, an embodiment of this application provides a chip system. The chip system includes a processor, may further include a communication interface, and is configured to implement the method according to any one of the first aspect to the eighth aspect. Optionally, the chip system further includes a memory. The memory is configured to store a computer program (which may also be referred to as code or instructions). The processor is configured to invoke the computer program from the memory and run the computer program, so that a device on which the chip system is installed performs the method according to any one of the first aspect to the eighth aspect and any possible implementation of the first aspect to the eighth aspect. The chip system may include a chip, or may include a chip and another discrete component.

According to a thirteenth aspect, an embodiment of this application provides a communication apparatus. The communication apparatus includes an input/output interface and a logic circuit. The input/output interface is configured to input and/or output information. The input/output interface may be an interface circuit, an output circuit, an input circuit, a pin, a related circuit, or the like. The logic circuit is configured to perform the method according to any one of the first aspect to the eighth aspect.

In a specific implementation process, the communication apparatus may be a chip, the input circuit may be an input pin, the output circuit may be an output pin, and the logic circuit may be a transistor, a gate circuit, a trigger, various logic circuits, or the like. An input signal received by the input circuit may be received and entered by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the input/output interface and the logic circuit are not limited in this application.

In an implementation, when the communication apparatus is a wireless communication device, the wireless communication device may be a terminal device like a mobile phone, or the wireless communication device may be a network device like a base station. The interface circuit may be a radio frequency processing chip in the wireless communication device, and the processing circuit may be a baseband processing chip in the wireless communication device.

According to a fourteenth aspect, an embodiment of this application provides a communication system. The communication system includes a terminal device and a network device. The terminal device is configured to implement the function of the method according to the first aspect, and the network device is configured to implement the function of the method according to the fifth aspect. Alternatively, the terminal device is configured to implement a function of a behavior in the method example according to the second aspect, and the network device is configured to implement a function of a behavior in the method example according to the sixth aspect. The terminal device is configured to implement a function of a behavior in the method example according to the third aspect, and the network device is configured to implement a function of a behavior in the method example according to the seventh aspect. The terminal device is configured to implement a function of a behavior in the method example according to the fourth aspect, and the network device is configured to implement a function of a behavior in the method example according to the eighth aspect.

According to a fifteenth aspect, an embodiment of this application provides a computer-readable storage medium. The computer-readable storage medium is configured to store a computer program or instructions. When the computer program or the instructions are run, the method according to any one of the first aspect to the eighth aspect and the implementations of the first aspect to the eighth aspect is implemented.

According to a sixteenth aspect, an embodiment of this application further provides a computer program product including instructions. When the computer program product runs on a computer, the method according to any one of the first aspect to the eighth aspect and the implementations of the first aspect to the eighth aspect is implemented.

For beneficial effect of the ninth aspect to the sixteenth aspect and the implementations of the ninth aspect to the sixteenth aspect, refer to beneficial effect of the first aspect to the fourth aspect and the implementations of the first aspect to the fourth aspect.

### BRIEF DESCRIPTION OF DRAWINGS

FIG. 1 is a diagram of an architecture of a communication system according to an embodiment of this application;

FIG. 2 is a diagram of an architecture of a communication system according to an embodiment of this application;

FIG. 3 is a schematic flowchart of a communication method 300 according to an embodiment of this application;

FIG. 4 is a diagram of M measurement results according to an embodiment of this application;

FIG. 5 is another diagram of M measurement results according to an embodiment of this application;

FIG. 6 is a schematic flowchart of a communication method 600 according to an embodiment of this application;

FIG. 7 is a diagram of P measurement results according to an embodiment of this application;

FIG. 8 is a diagram of a structure of a communication apparatus according to an embodiment of this application; and

FIG. 9 is a diagram of another structure of a communication apparatus according to an embodiment of this application.

### DESCRIPTION OF EMBODIMENTS

In embodiments of this application, a terminal device reports resource measurement results that meet a specific condition, for a network device to perform MU pairing. Interference between resources corresponding to the resource measurement results that meet the specific condition is small, so that communication interference between MU pairs determined by the network device is small, and communication exceptions can be reduced. The following describes the solutions provided in embodiments of this application with reference to the accompanying drawings.

The technical solutions provided in embodiments of this application may be applied to a communication system related to the 3rd generation partnership project (3GPP), for example, a long term evolution (LTE) communication system or a fifth generation (5G) mobile communication system, or may be applied to another next-generation mobile communication system, for example, a sixth generation (6G) communication system, or another similar communication system. The another similar communication system may include a wireless fidelity (Wi-Fi) system, a vehicle-to-everything (V2X) system, an internet of things (IoT) system, a narrowband internet of things (NB-IoT) system, and the like.

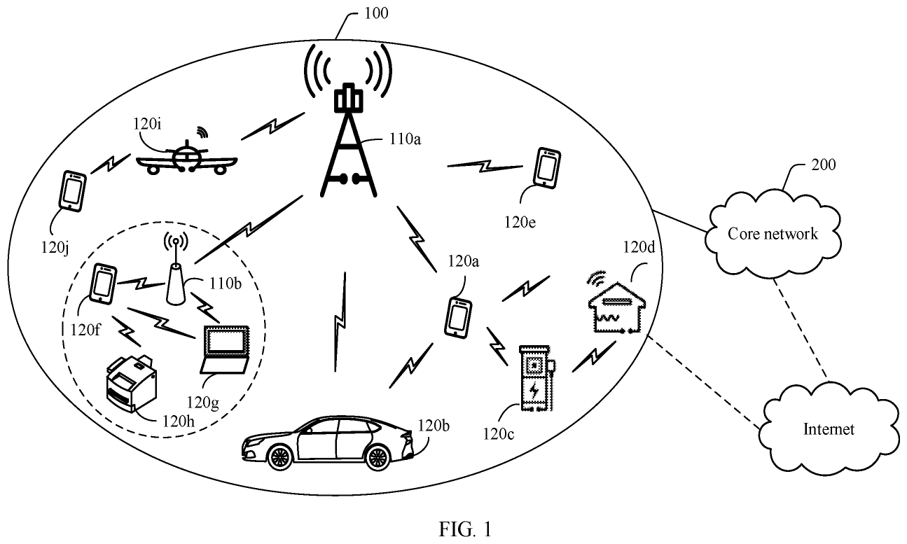

FIG. 1 shows a communication system to which an embodiment of this application is applicable. The communication system includes a radio access network 100 and a core network 200. Optionally, the communication system may further include an internet (this is used as an example in FIG. 1).

The radio access network 100 may include at least one network device and at least one terminal device. For example, the radio access network 100 includes two network devices 110a and 110b and terminal devices 120a to 120j. A network architecture shown in FIG. 1 is merely an example, and there may be fewer or more terminal devices and/or network devices. The communication system described in embodiments of this application is intended to describe the technical solutions in embodiments of this application more clearly, but constitutes no limitation on the communication system to which embodiments of this application are applicable. For example, the communication system may further include another device, and the another device includes, for example, a wireless relay device and a wireless backhaul device, which are not shown in FIG. 1. A person of ordinary skill in the art may learn that with evolution of the network architecture, the technical solutions provided in embodiments of this application are also applicable to a similar technical problem. When the technical solutions in embodiments of this application are applied to another communication system, devices, components, modules, and the like in embodiments may be replaced with corresponding devices, components, and modules in the another communication system. This is not limited.

In embodiments of this application, the network device is a radio access network (RAN) device. The RAN may be a 3GPP-related cellular system, for example, a 5G/new radio (NR) mobile communication system, or a future-oriented evolved system (for example, a 6G mobile communication system). Alternatively, the RAN may be an open access network (open RAN, O-RAN, or ORAN), a cloud radio access network (CRAN), a virtualized radio access network (virtualized RAN, or vRAN), or the like. Alternatively, the RAN may be a communication system that integrates two or more of the foregoing systems. The RAN device may also be referred to as a RAN node, a RAN entity, an access node, or the like.

In a possible scenario, the RAN node may be a base station, an evolved NodeB (eNodeB), an access point (AP), a transmission reception point (TRP), a next generation NodeB (gNB), a next generation base station in a 6G mobile communication system, a base station in a future mobile communication system, or the like. The RAN node may be a macro base station, a micro base station, an indoor base station, a relay node, a donor node/host node, a radio controller, or the like. Alternatively, the RAN node may be a server, a wearable device, a vehicle, a vehicle-mounted device, or the like. For example, a RAN node in a V2X technology may be a road side unit (RSU).

In another possible scenario, the RAN node may be a module or unit that completes some functions of a base station; or a plurality of RAN nodes cooperate to assist a terminal device in implementing radio access, and different RAN nodes separately implement some functions of a base station. For example, the RAN node may be a central unit (CU), a distributed unit (DU), or a radio unit (RU). Functions of the CU may be implemented by one entity, or may be implemented by different entities. For example, the functions of the CU may be further divided, that is, a control plane and a user plane are separated and implemented by different entities, which are respectively a control plane CU entity (namely, a CU-control plane (CP) entity, or CU-CP entity) and a user plane CU entity (namely, a CU-user plane (UP) entity, or CU-UP entity). The CU-CP entity and the CU-UP entity may be coupled to the DU, to jointly complete functions of the RAN node. The CU and the DU may be separately disposed, or may be included in a same network element, for example, a baseband unit (BBU).

In different systems, a CU (or a CU-CP and a CU-UP), a DU, or an RU may also have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

The CU and the DU may be configured based on protocol layer functions of a wireless network implemented by the CU and the DU. For example, the CU is configured to implement functions of a packet data convergence protocol (PDCP) layer and a protocol layer (for example, a radio resource control (RRC) layer and/or a service data adaptation protocol (SDAP) layer) above the PDCP layer. The DU is configured to implement a function of a protocol layer (for example, a radio link control (RLC) layer, a media access control (MAC) layer, and/or a physical (PHY) layer) below the PDCP layer. For another example, the CU is configured to implement functions of protocol layers (for example, an RRC layer and/or an SDAP layer) above a PDCP layer; and the DU is configured to implement functions of the PDCP layer and protocol layers (for example, an RLC layer, a MAC layer, and/or a PHY layer) below the PDCP layer. For specific descriptions of the foregoing protocol layers, refer to a related technical specification of the 3GPP or a technical specification of another applicable communication protocol. Division into processing functions of the CU and the DU based on the protocol layers is merely an example. Division may alternatively be performed in another manner. This is not limited in this application. For example, in a design, the CU or the DU may alternatively have a part of processing functions of a protocol layer through division. In a design, a part of functions of the RLC layer and functions of the protocol layers above the RLC layer are set on the CU, and remaining functions of the RLC layer and functions of the protocol layers below the RLC layer are set on the DU.

In embodiments of this application, an apparatus configured to implement a function of the network device may be the network device, or may be an apparatus that can support the network device in implementing the function, for example, a chip system or a combined device or component that can implement the function of the network device. The apparatus may be installed in the network device. Neither of a specific technology and a specific device form used by the network device is limited in embodiments of this application.

In embodiments of this application, any device that can perform data communication with a base station may be considered as the terminal device. The terminal device is also referred to as a terminal, a terminal apparatus, a user equipment (UE), a mobile station, a mobile terminal, or the like. The terminal device may be widely used in various scenarios. For example, the terminal device may be a mobile phone, a computer, a mobile internet device (MID), a wearable device, a virtual reality (VR) device, an augmented reality (AR) device, a station (STA), a robot arm, a camera, a robot, a vehicle, a drone, a helicopter, an airplane, a ship, a smart home device (for example, a television, an air conditioner, a robot vacuum, a sound box, or a set-top box), a relay, customer-premises equipment (CPE), a smart car (smart car or intelligent car), a roadside unit (RSU), or the like. Alternatively, the terminal device may be a terminal device in an IoT system, for example, a water meter, an electricity meter, or the like.

If the various terminal devices described above are located on a vehicle (for example, placed/installed in the vehicle), the terminal devices may all be considered as vehicle-mounted terminal devices. The vehicle-mounted terminal device may be a vehicle-mounted module, a vehicle-mounted assembly, a vehicle-mounted component, a vehicle-mounted chip, or an on-board unit that is built in a vehicle as one or more components or units. The vehicle may implement the methods in this application through the built-in vehicle-mounted module, vehicle-mounted assembly, vehicle-mounted component, vehicle-mounted chip, or on-board unit. The vehicle-mounted terminal device may be an entire vehicle device, a vehicle-mounted module, a vehicle, an on-board unit (OBU), a roadside unit (RSU), an in-vehicle infotainment system (also referred to as an in-vehicle sending unit) (telematics box, or T-box), a chip, a system on chip (SoC), or the like. The chip or the SoC may be installed in the vehicle, the OBU, the RSU, or the T-box.

In embodiments of this application, an apparatus configured to implement a function of the terminal device may be the terminal device, or may be an apparatus that can support the terminal device in implementing the function, for example, a chip system or a combined device or component that can implement the function of the terminal device. The apparatus may be installed in the terminal device. Neither of a specific technology and a specific device form used by the terminal device is limited in embodiments of this application.

A fifth generation mobile communication system (5G) supports a technology for forming a beam. The beam may be understood as a spatial filter or a spatial parameter. A beam used to send a signal may be referred to as a transmission beam (Tx beam), a spatial domain transmit filter (spatial domain transmit filter), or a spatial transmit parameter (spatial Tx parameter). The transmission beam may indicate signal strength distribution formed in different directions in space after a signal is transmitted via an antenna. From this perspective, the transmission beam may also be expressed as a spatial transmit angle (for example, an azimuth angle Azimuth or a zenith angle Zenith), a spatial transmit angle range (for example, an azimuth center angle and an azimuth offset, azimuth angle uncertainty, an azimuth angle protection range, a zenith center angle and a zenith offset, zenith angle uncertainty, or a zenith angle protection range), or the like. Correspondingly, a beam used to receive a signal may be referred to as a reception beam (Rx beam), a spatial domain receive filter, or spatial receive parameter (spatial Rx parameter). The reception beam may also indicate signal strength distribution, in different directions in space, of a radio signal received through an antenna. From this perspective, the reception beam may also be expressed as a spatial receive angle (for example, an azimuth angle Azimuth or a zenith angle Zenith), a spatial receive angle range (for example, an azimuth center angle and an azimuth offset, azimuth angle uncertainty, an azimuth angle protection range, a zenith center angle and a zenith offset, zenith angle uncertainty, or a zenith angle protection range), or the like.

The technology for forming a beam is also referred to as a beamforming technology, and may be specifically a digital beamforming technology, an analog beamforming technology, a hybrid digital/analog beamforming technology, or the like. Based on the beamforming technology, a device may send a signal through a plurality of beams. In this way, a transmit end and a receive end need to use a specific beam pair for transmission, so that a large beamforming gain can be obtained for signal transmission between a transmit beam and a receive beam. A beam pairing relationship (beam pair link, or BPL) between the transmit end and the receive end, namely, a pairing relationship between the transmit beam and the receive beam, may also be referred to as a pairing relationship between the spatial domain transmit filter and the spatial domain receive filter.

A beam pairing process between the transmit end and the receive end is as follows: The transmit end sends a reference signal in a beam sweeping manner, and performs polling on a plurality of beams with different directivity. The receive end may also form, in a beamforming manner, receive beams corresponding to different spatial directions and directivity, and may perform polling on the plurality of beams with different directivity, to receive the reference signal through the beams with different directivity. During the process, the receive end may perform measurement based on the received reference signal, and report a measurement result to the transmit end, to determine the beam pairing relationship between the transmit end and the receive end. For example, the receive end may report, to the transmit end, a reference signal resource with relatively high reference signal received power (RSRP), so that the transmit end determines the beam pairing relationship between the transmit end and the receive end based on the reference signal resource with high RSRP.

For example, the transmit end is a network device, and the receive end is a terminal device. The network device configures a measurement resource set for the terminal device. The measurement resource set includes a plurality of beams and a reporting quantity F. The plurality of beams are measurement resources, and F is a positive integer. The reporting quantity indicates a quantity of measured resources that the terminal device needs to report. The terminal device measures a plurality of measurement resources, to obtain a measurement result of each measurement resource, where the measurement result may be RSRP. The terminal device may sort the obtained measurement results in descending order, and report first F measurement results to the network device. The network device determines a final beam pair between the network device and the terminal device based on the F measurement results. For example, the network device selects, from the F measurement results, a beam corresponding to a measurement result that is greater than an RSRP threshold as a serving beam, to obtain high communication quality. The terminal device reports at least one measurement result to the network device in a differential manner. For example, the terminal device reports four measurement results. The terminal device reports a first measurement result and a difference between the first measurement result and each of the remaining three measurement results. In NR, a maximum supported value of the difference may be 30 dB.

When it is considered that interference is inevitable in a communication process, the network device may configure at least one channel measurement resource and at least one interference measurement resource. One channel measurement resource corresponds to one interference measurement resource, and the channel measurement resource and the interference measurement resource are configured by using semi-static signaling. The terminal device measures the channel measurement resource and the interference measurement resource, to obtain a measurement result. The measurement result may be a signal to interference plus noise ratio (SINR). The terminal device reports the measurement result to the network device in a differential manner. The terminal device may report, to the network device, a measurement result that is greater than an SINR threshold, so that an SINR for a final beam pair between the network device and the terminal device is high, to obtain high communication quality. In this process, RRC reconfiguration is required to configure a measurement resource pair, and a delay is large.

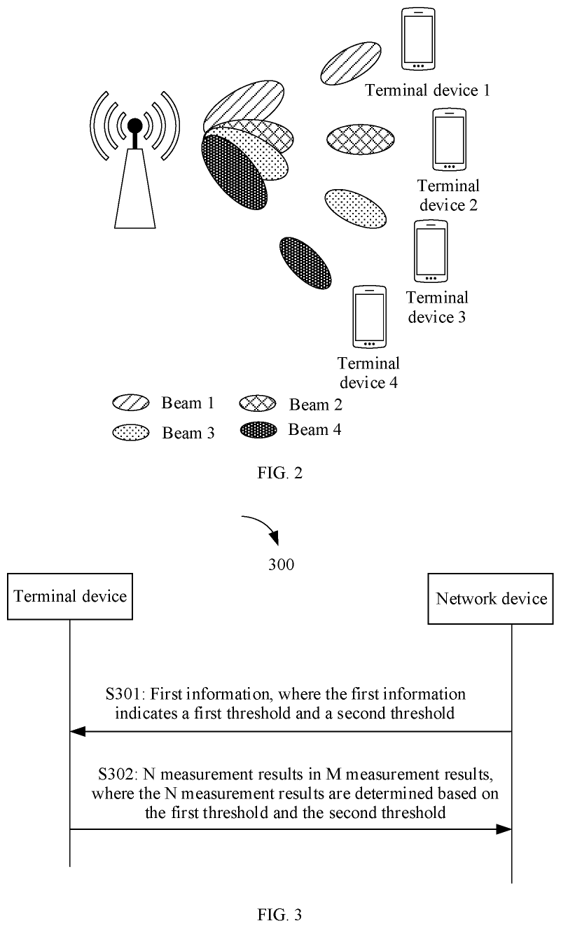

In a possible scenario, multi-beam spatial division transmission is supported, that is, multi-beam MU multiplexing/transmission is supported. The multi-beam MU transmission may also be understood as that, at the same time, the transmit end may communicate with a plurality of receive ends through a plurality of beams. For example, FIG. 2 is a diagram of multi-beam MU transmission according to an embodiment of this application. In FIG. 2, an example in which the transmit end is a network device and the receive ends include a terminal device 1 to a terminal device 4 is used. The terminal device 1 to the terminal device 4 are in a one-to-one correspondence with a beam 1 to a beam 4. For example, the network device communicates with the terminal device 1 through the beam 1, communicates with the terminal device 2 through the beam 2, and so on.

It may be understood that interference may exist between one beam and another beam. FIG. 2 is used as an example. If the beam 2 causes interference to the beam 1, the terminal device 1 and the terminal device 2 cannot perform multi-beam MU transmission. Otherwise, the terminal device 1 and the terminal device 2 cause interference to each other, resulting in a communication exception. Therefore, the network device needs to determine terminal devices that can perform multi-beam MU transmission. Determining the terminal devices that can perform multi-beam MU transmission may also be understood as determining MU pairs.

In an implementation, the network device configures, for candidate paired terminal devices, a measurement resource set used for MU pairing. The candidate paired terminal devices are a plurality of terminal devices that can perform multi-beam MU transmission. The measurement resource set may include a serving beam corresponding to each of the candidate paired terminal devices. FIG. 2 is used as an example. The candidate paired terminal devices are the terminal device 1 to the terminal device 4, and the measurement resource set configured by the network device for the four devices includes serving beams of the four terminal devices, for example, the beam 1 to the beam 4. Each terminal device may measure the beam 1 to the beam 4, and the network device determines, based on measurement results of the beam 1 to the beam 4 by each terminal device, the terminal devices that can perform multi-beam MU transmission.

A serving beam of each terminal device is selected by the network device based on measurement results reported by the terminal device in a beam pairing process. For example, the terminal device measures 64 beams, and reports measurement results of four candidate beams to the network device. Typically, the four candidate beams are first four beams obtained by sorting the 64 beams in descending order of RSRP. The example in FIG. 2 is still used. For the terminal device 1, four candidate beams are the beam 1 to the beam 4, where the beam 1 has highest RSRP. However, for the network device, because each terminal device separately reports respective measurement results, and the measurement results do not involve interference measurement, the network device does not know whether the beam 2 to the beam 4 cause interference to the beam 1. Therefore, if the network device uses the serving beams of the terminal devices as a measurement beam set used for MU pairing, interference between a plurality of determined MU transmission users may be large, and communication is abnormal. However, if the measurement results of all resources reported by each terminal device are used for MU pairing, each terminal device reports a large amount of data, and resource overheads are high.

In view of this, the technical solutions in embodiments of this application are provided. In embodiments of this application, the terminal device reports a resource measurement result that meets a specific condition, for the network device to perform MU pairing, so that there is little interference or even no interference between a plurality of users in MU transmission, thereby improving communication quality. For example, the terminal device may report a first measurement result in which RSRP is greater than a threshold (namely, a first threshold in this specification), and report at least one measurement result for which a difference between RSRP and the RSRP corresponding to the first measurement result is greater than a threshold (namely, a second threshold in this specification). When RSRP of one beam is greater than the first threshold, it may be considered that communication quality through the beam is good. When a difference between RSRP corresponding to one beam and RSRP corresponding to another beam is large, it may be considered that interference between the two beams is low. Because resources corresponding to measurement results included in the terminal devices include both a resource with good communication quality and a resource with low interference to the resource, the network device performs MU pairing based on the measurement results reported by the terminal devices, so that MU pairs with low interference and good communication quality can be obtained, and communication exceptions can be reduced. In addition, in comparison with a case in which the terminal device reports all measurement results, in this case, the terminal device reports only the resource measurement result that meets the specific condition, so that resource overheads can be reduced.

In embodiments of this application, a measurement resource may include a synchronization signal and physical broadcast channel (PBCH) block (synchronization signal and PBCH block, or SSB) resource, a channel state information-reference signal (CSI-RS) resource, or the like. The measurement resource includes a measurement resource in space domain, for example, a beam resource/beam. Resource measurement means measuring a signal received through the resource.

In embodiments of this application, “when”, “as if”, and “if” all mean that an apparatus performs corresponding processing in an objective case, are not intended to limit time, do not require the apparatus to necessarily have a determining action during implementation, and do not mean another limitation. Unless otherwise specified, “if” and “as if” are interchangeable, and “when” and “in the case of” are interchangeable. In addition, “when” and “if”/“as if” are interchangeable.

In embodiments of this application, the word “example”, “for example”, or the like is used to represent giving an example, an illustration, or a description. Any embodiment or design scheme described as an “example” or “for example” in this application should not be explained as being more preferred or having more advantages than another embodiment or design scheme. Exactly, use of the word “example”, “for example” or the like is intended to present a relative concept in a specific manner.

In embodiments of this application, “sending” and “receiving” represent signal transfer directions. For example, “sending information to XX” may be understood as that a destination end of the information is XX, and may include direct sending through an air interface, or include indirect sending through an air interface by another unit or module. “Receiving information from YY” may be understood as that a source end of the information is YY, and may include direct receiving from YY through an air interface, or may include indirect receiving from YY through an air interface from another unit or module. “Sending” may alternatively be understood as “output” of a chip interface, and “receiving” may alternatively be understood as “input” of the chip interface.

In other words, sending and receiving may be performed between devices, for example, between a network device and a terminal device; or may be performed inside a device, for example, sending or receiving is performed between components, modules, chips, software modules, or hardware modules inside the device through a bus, a trace, or an interface.

It can be understood that necessary processing, for example, encoding or modulation, may be performed on information between a source end that sends the information and a destination end, but the destination end can understand valid information from the source end. Similar descriptions in this application may be understood similarly. Details are not described again.

In embodiments of this application, unless otherwise specified, a quantity of nouns indicates “a singular noun or a plural noun”, namely, “one or more”. “At least one” indicates one or more, and “a plurality of” indicates two or more. The term “and/or” describes an association relationship between associated objects, and indicates that three relationships may exist. For example, A and/or B may indicate the following three cases: A exists alone, both A and B exist, and B exists alone, where A and B may be singular or plural. The character “/” generally indicates an “or” relationship between associated objects. For example, A/B indicates A or B. “At least one of the following items (pieces)” or a similar expression thereof indicates any combination of these items, including a single item (piece) or any combination of a plurality of items (pieces). For example, at least one of a, b, or c indicates a, b, c, a and b, a and c, b and c, or a, b, and c, where a, b, and c may be singular or plural.

Ordinal numbers such as “first” and “second” mentioned in embodiments of this application are intended to distinguish between a plurality of objects, but not to limit a size, content, an order, a time sequence, a priority, or importance of the plurality of objects. For example, the first threshold and the second threshold are two different thresholds, and do not indicate that the two thresholds are different in content, priorities, importance, or the like.

The following describes, with reference to the accompanying drawings, the solutions provided in embodiments of this application. In the following descriptions, an example in which the communication method provided in embodiments of this application is applied to the network architecture shown in FIG. 1 or FIG. 2 is used. The network architecture and application scenarios described in embodiments of this application are intended to describe the technical solutions in embodiments of this application more clearly, and do not constitute a limitation to the technical solutions provided in embodiments of this application. A person of ordinary skill in the art may know: With evolution of the network architecture and emergence of new application scenarios, the technical solutions provided in embodiments of this application are also applicable to similar technical problems.

The following describes the communication method by using an example in which the communication method provided in embodiments of this application is performed by a network device and a terminal device. Steps performed by the network device may be implemented by a RAN device, or may be implemented by a component (for example, a module like a baseband chip, or another processing unit or processor) in the RAN device. For example, the network device may be the network device in FIG. 1, for example, the network device 110a, or may be a chip (system) in the network device in FIG. 1. Steps performed by the terminal device may be implemented by the terminal device, or may be implemented by a component (for example, a module like a chip, a processing unit, or a processor) in the terminal device. The terminal device may be the terminal device shown in FIG. 1, for example, the terminal device 120a, or may be a chip (system) in the terminal device in FIG. 1.

Refer to FIG. 3. FIG. 3 is a schematic flowchart of a communication method 300 according to an embodiment of this application. In FIG. 3, the method is described from a perspective of interaction between a network device and a terminal device. It should be understood that the communication method 300 may alternatively be implemented by another apparatus, for example, a chip or a communication apparatus that has a communication function. It should be noted that embodiments of this application are merely described by using the network device and the terminal device as an example, and are not limited to the network device and the terminal device. For example, embodiments of this application may alternatively be performed by more terminal devices. When more terminal devices are involved, the more terminal devices perform a same procedure. As shown in FIG. 3, a procedure of the communication method 300 includes the following steps.

S301: The network device sends first information to the terminal device, where the first information indicates a first threshold and a second threshold.

The first threshold may indicate the terminal device to report a measurement result in which a signal strength is higher than or equal to the first threshold. If a signal strength corresponding to a measurement result is higher than or equal to the first threshold, the terminal device may report the measurement result. A specific name of the first threshold is not limited in embodiments of this application. For example, the first threshold may be referred to as a signal strength threshold, for example, an RSRP threshold. In embodiments of this application, the first threshold may be used by the network device to perform MU pairing. From this perspective, the first threshold may also be referred to as a pairing threshold.

The second threshold may indicate the terminal device to report a measurement result for which a difference between a signal strength and the signal strength corresponding to the first measurement result is greater than or equal to the second threshold. For example, if a difference between a signal strength corresponding to a measurement result and the signal strength corresponding to the first measurement result is greater than or equal to the second threshold, the terminal device may report the measurement result. On the contrary, if a difference between a signal strength corresponding to a measurement result and the signal strength corresponding to the first measurement result is less than the second threshold, the terminal device does not report the measurement result. Alternatively, if a difference between a signal strength corresponding to a measurement result and the signal strength corresponding to the first measurement result is greater than the second threshold, the terminal device may report the measurement result. On the contrary, if a difference between a signal strength corresponding to a measurement result and the signal strength corresponding to the first measurement result is less than or equal to the second threshold, the terminal device does not report the measurement result.

If a difference between signal strengths corresponding to measurement results of two resources is large, it may be considered that interference between the two resources is low or even there is no interference, and the two resources may be used as candidate resources for multi-beam MU transmission. On the contrary, if a difference between signal strengths corresponding to measurement results of two resources is small, it may be considered that interference exists between the two resources or the interference is large, and the two resources cannot be used as candidate resources for multi-beam MU transmission. Otherwise, a communication exception is caused. Therefore, setting of the second threshold can ensure that interference between resources corresponding to measurement results reported by the terminal device is low, and the resources are more suitable to be used as candidate resources for MU pairing. In addition, setting of the second threshold can further reduce a quantity of measurement results reported by the terminal device, thereby reducing resource overheads. A specific name of the second threshold is not limited in embodiments of this application. For example, the second threshold may be referred to as an isolation threshold, an interference threshold, or a pairing threshold.

The first threshold and the second threshold may indicate the terminal device to report a measurement result of a measurement resource based on the first threshold and the second threshold. For example, the first threshold and the second threshold may indicate the terminal device to report the first measurement result in which the signal strength is greater than or equal to the first threshold, and report the measurement result for which the difference between the signal strength and the signal strength corresponding to the first measurement result is greater than or equal to the second threshold. In this way, it can be ensured that communication quality of a resource corresponding to a measurement result reported by the terminal device is good, and interference is low. The network device may perform multi-beam MU pairing based on the measurement result reported by the terminal device, to reduce communication exceptions.

A value of the first threshold and a value of the second threshold may be obtained based on a historical experiment. For example, the first threshold may be −60 dB, and the second threshold may be 20 dB. The network device may configure the first threshold and the second threshold for the terminal device. For example, the network device sends the first information to the terminal device, where the first information may indicate the first threshold and the second threshold. Correspondingly, the terminal device receives the first information, and determines the first threshold and the second threshold based on the first information.

The first information may be carried in one or more of RRC, downlink control information (DCI), or a MAC control element (CE) (MAC CE). A specific name of the first information is not limited in embodiments of this application. For example, the first information may also be referred to as resource selection information, measurement result reporting configuration information, or the like. Optionally, the first threshold and/or the second threshold may be (pre)configured. For example, the first threshold may be preconfigured/predefined, and the second threshold is indicated by using the first information. In this case, the first information indicates the second threshold, and does not indicate the first threshold. For another example, the second threshold may be preconfigured/predefined, and the first threshold is indicated by using the first information. In this case, the first information indicates the first threshold, and does not indicate the second threshold.

S302: The terminal device sends N measurement results in M measurement results to the network device, where the N measurement results are determined based on the first threshold and the second threshold. In other words, the terminal device sends the N measurement results in the M measurement results to the network device based on the first threshold and the second threshold.

The terminal device may report a measurement result of a measurement resource to the network device based on the first threshold and the second threshold. For ease of description, in the following, an example in which the terminal device reports the N measurement results in the M measurement results to the network device is used in embodiments of this application, and an example in which the signal strength corresponding to the first measurement result is greater than or equal to the first threshold is used. It may be understood that the M measurement results correspond to M measurement resources. A measurement result corresponding to a measurement resource is a result obtained by measuring a reference signal received through the measurement resource. The N measurement results include the first measurement result, and both M and N are integers greater than 1.

The M measurement resources may be all resources in a first resource set. The terminal device measures all the resources in the first resource set, to obtain the M measurement results. In this way, the network device can obtain sufficient information about the resources to perform multi-beam MU transmission pairing, so that interference between MU pairs is low or even there is no interference, to achieve good communication quality. The first resource set may be (pre)configured/predefined. For example, the first resource set is preconfigured/predefined. For another example, the network device may send second information to the terminal device, where the second information may indicate the first resource set. For example, the second information may include an index of the first resource set, or the second information includes an index of each resource in the first resource set. The second information may be carried in RRC signaling or MAC CE signaling. Alternatively, the network device may indicate the first resource set by using the first information, that is, the first information may indicate the first threshold, the second threshold, and the first resource set; or the first information may indicate the first threshold and the first resource set, and the second threshold is predefined or preconfigured; or the first information may indicate the second threshold and the first resource set, and the first threshold is predefined or preconfigured.

In a possible scenario, the terminal device does not need to measure all the resources in the first resource set. In this case, the M measurement resources are some resources in the first resource set, so that a measurement process and a data reporting amount of the terminal device are reduced, thereby reducing processing complexity and power consumption of the terminal device. The network device may indicate the M measurement resources to the terminal device, so that the terminal device measures the M measurement resources, and does not need to measure all the resources in the first resource set.

In an implementation, the network device may directly indicate the M measurement resources. For example, the network device indicates the M measurement resources by using the first information. The first information may include indexes of the M measurement resources. Certainly, the network device may alternatively indicate the M measurement resources by using other information. For example, the network device may alternatively indicate the M measurement resources by using information X. In this case, the first threshold and the second threshold may be carried in one piece of signaling, and indication of the M measurement resources is carried in another piece of signaling. In a possible implementation, the first threshold and the second threshold may alternatively be carried in different signaling.

The network device may alternatively indicate that the M measurement resources are M measurement resources in the first resource set. For example, the network device indicates the first resource set by using the second information, and indicates the M measurement resources in the first resource set by using the first information. A manner in which the second information indicates the first resource set is as described above. That the first information indicates the M measurement resources in the first resource set includes but is not limited to the following several cases: (1) The first information includes the indexes of the M measurement resources in the first resource set. (2) If the M measurement resources are a group of resources in the first resource set, the first information may include an index of the group in which the M measurement resources are located in the first resource set. (3) The first information is a bitmap with a length L, L is a quantity of resources included in the first resource set, one bit corresponds to one resource, and the M measurement resources are resources corresponding to bits whose values are “1” or “0” in the bitmap. Certainly, the network device may alternatively indicate the M measurement resources by using other information. For example, the network device may alternatively indicate the M measurement resources in the first resource set by using information Y.

A value of N may be (pre)configured/predefined. The value of N may be indicated by using the first information, or may be indicated by using the second information. The M measurement results, the value of N, the first threshold, and the second threshold are carried in one piece of signaling, or may be carried in a plurality of pieces of signaling.

For example, the M measurement results are all the resources in the first resource set. There are the following several cases: (A) The first resource set and the value of N are preconfigured/predefined, and the first information may indicate the first threshold and the second threshold. (B) The first resource set is configured, the value of N is preconfigured/predefined, and the first information may indicate the first threshold, the second threshold, and the first resource set; or the first information indicates the first threshold and the second threshold, and the second information indicates the first resource set. (C) The first resource set is preconfigured/predefined, the value of N is configured, and the first information may indicate the first threshold, the second threshold, and the value of N; or the first information indicates the first threshold and the second threshold, and the second information indicates the value of N.

For example, the M measurement results are some resources in the first resource set. There are the following several cases: (A) The first resource set and the value of N are preconfigured/predefined, and the first information may indicate the first threshold, the second threshold, and the M measurement resources; or the first information indicates the first threshold and the second threshold, and the second information indicates the M measurement resources. (B) The first resource set is configured, the value of N is preconfigured/predefined, the first information may indicate the first threshold, the second threshold, and the M measurement resources, and the second information indicates the first resource set. (C) The first resource set is preconfigured/predefined, the value of N is configured, and the first information may indicate the first threshold, the second threshold, and the value of N; or the first information indicates the first threshold and the second threshold, and the second information indicates the value of N.

The terminal device measures the M measurement resources to obtain the M measurement results, and reports the N measurement results in the M measurement results to the network device. Before reporting the N measurement results, the terminal device may sort the M measurement results in descending order of signal strengths, and determine a measurement result corresponding to a maximum signal strength as the first measurement result. That the terminal device may report the N measurement results to the network device based on the first threshold and the second threshold includes the following two cases. For ease of description, the following uses an example in which N is greater than or equal to 2.

Case A: If the signal strength corresponding to the first measurement result is greater than or equal to the first threshold, the terminal device may report the first measurement result to the network device. In addition, the terminal device further reports N−1 measurement results other than the first measurement result to the network device, where a difference between a signal strength corresponding to each of the N−1 measurement results and the signal strength corresponding to the first measurement result is greater than or equal to the second threshold.

Case A may alternatively be understood as the following: When the signal strength corresponding to the first measurement result is greater than or equal to the first threshold, the terminal device reports N−1 measurement results in addition to the first measurement result, where each of the N−1 measurement results meets a specific condition, and the specific condition is that a difference between a signal strength corresponding to the measurement result and the signal strength corresponding to the first measurement result is greater than or equal to the second threshold. Alternatively, Case A may be understood as the following: The terminal device reports a measurement result that meets a specific condition, where the specific condition includes: The terminal device reports the first measurement result when the signal strength corresponding to the first measurement result is greater than or equal to the first threshold; and the terminal device further reports N−1 measurement results for which a difference between a signal strength corresponding to each of the N−1 measurement results and the signal strength corresponding to the first measurement result is greater than or equal to the second threshold.

The example in FIG. 2 is still used, and the terminal device 1 is used as an example. It is assumed that the terminal device measures the beam 1 to the beam 4, where a signal strength corresponding to the beam 1 is the maximum, a difference between a signal strength corresponding to the beam 2 and the signal strength corresponding to the beam 1 is less than the second threshold, a difference between a signal strength corresponding to the beam 3 and the signal strength corresponding to the beam 1 is greater than the second threshold, and a difference between a signal strength corresponding to the beam 4 and the signal strength corresponding to the beam 1 is greater than the second threshold. In this case, the terminal device reports respective measurement results of the beam 1, the beam 3, and the beam 4 to the network device.

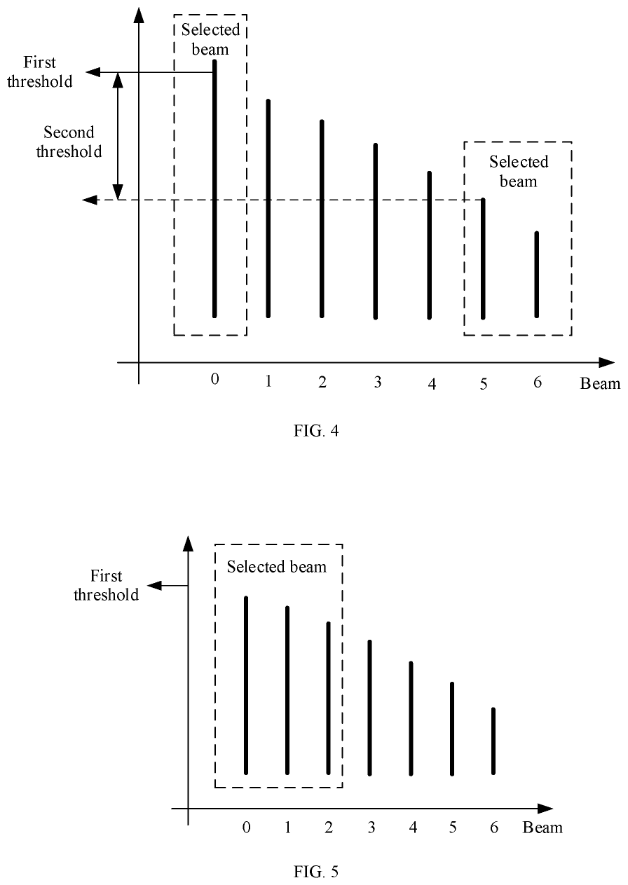

For ease of understanding, FIG. 4 is a diagram of the M measurement results according to an embodiment of this application. In FIG. 4, a beam is used as an example of a resource, and M=7 and N=3 are used as an example. It can be learned from FIG. 4 that the first measurement result is a measurement result of a beam 0. Differences between signal strengths corresponding to measurement results of the beam 1 to the beam 4 and a signal strength corresponding to the measurement result of the beam 0 are less than the second threshold, and differences between signal strengths corresponding to measurement results of the beam 5 and the beam 6 and the signal strength corresponding to the measurement result of the beam 0 are greater than the second threshold. Finally, the terminal device reports measurement results of the beam 0, the beam 5, and the beam 6 to the network device (selected beams as shown by dashed lines in FIG. 4).

It may be understood that, if a difference between signal strengths corresponding to measurement results of two resources is large, for example, the difference is greater than an SINR or a signal to interference ratio (SIR), it may be considered that interference between the two resources is low, and the two resources may be used as candidate resources for multi-beam MU transmission. On the contrary, if a difference between signal strengths corresponding to measurement results of two resources is small, it may be considered that interference exists when MU transmission is performed through the two resources. The example in FIG. 2 is still used. For the terminal device 1, if a signal strength corresponding to the beam 1 is greater than or equal to the first threshold, and a difference between a signal strength corresponding to the beam 2 and the signal strength corresponding to the beam 1 is less than the second threshold, it may be considered that the beam 2 causes interference to the beam 1. If the beam 2 is a serving beam of the terminal device 2, the network device may determine that the beam 1 and the beam 2 cannot be used for MU transmission. If a difference between a signal strength corresponding to the beam 3 and the signal strength corresponding to the beam 1 is greater than the second threshold, it may be considered that the beam 3 does not cause interference to the beam 1. If the beam 3 is a serving beam of the terminal device 3, the network device may determine that the beam 1 and the beam 3 can be used for MU transmission.

In embodiments of this application, the second threshold is set, so that interference between resources corresponding to measurement results reported by the terminal device is small, and the resources can be used as candidate resources for MU pairing. In comparison with a case in which the network device performs MU pairing by using a serving beam of each terminal device as a candidate resource, in this case, interference between a plurality of determined users for MU transmission can be reduced, and communication exceptions can be reduced. In addition, the terminal device reports the N measurement results based on the first threshold and the second threshold. In comparison with a case in which a terminal device reports measurement results of all resources, in this case, an amount of data reported by each terminal device can be reduced, and resource overheads can be reduced.

Optionally, the N measurement results are the first measurement result and a second measurement result. The second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold. Here, T is an integer greater than or equal to 1. In other words, the terminal device reports, in addition to the first measurement result, the second measurement result corresponding to the maximum signal strength among the T measurement results that meet the specific condition. The example in FIG. 4 is used. The N measurement results may be a measurement result of the beam 0, a measurement result of the beam 5, and a measurement result of the beam 6. The network device may use a beam corresponding to the second measurement result as a candidate serving beam, to increase an MU pairing probability.

Case B: A signal strength corresponding to the first measurement result is less than or equal to the first threshold, and the N measurement results reported by the terminal device to the network device are first N measurement results obtained by sorting the M measurement results in descending order of signal strengths. Case B may alternatively be understood as the following: If the signal strength corresponding to the first measurement result is less than or equal to the first threshold, the terminal device reports N−1 measurement results in addition to the first measurement result, where the N−1 measurement results are first N−1 measurement results obtained by sorting the M measurement results except the first measurement result in descending order of signal strengths.

For ease of understanding, FIG. 5 is a diagram of the M measurement results according to an embodiment of this application. In FIG. 5, a beam is used as an example of a resource, and M=7 and N=3 are used as an example. It can be learned from FIG. 5 that the first measurement result is a measurement result of a beam 0. When the signal strength corresponding to the first measurement result is less than or equal to the first threshold, the terminal device further reports measurement results of a beam 1 and a beam 2 to the network device, and the terminal device finally reports measurement results of the beam 0, the beam 1, and the beam 2 to the network device (selected beams as shown by dashed lines in FIG. 5).

In Case B, although the signal strength corresponding to the first measurement result is less than or equal to the first threshold, the terminal device still reports the N measurement results including the first measurement result to the network device. The network device may perform multi-beam MU pairing based on the N measurement results.

It should be noted that, in Case B, the first information may alternatively not indicate the second threshold. In other words, the first information indicates the first threshold, and does not indicate the second threshold. In this case, the terminal device obtains the M measurement results, and the signal strength corresponding to the first measurement result is less than or equal to the first threshold. The N measurement results reported by the terminal device to the network device are first N measurement results obtained by sorting the M measurement results in descending order of signal strengths. Alternatively, the first information indicates the first threshold and the second threshold, the terminal device obtains the M measurement results, and the signal strength corresponding to the first measurement result is less than or equal to the first threshold. The N measurement results reported by the terminal device to the network device are first N measurement results obtained by sorting the M measurement results in descending order of signal strengths.

In the communication method 300, the first threshold and the second threshold are set, so that resources corresponding to measurement results reported by the terminal device are more suitable for the network device to perform multi-beam MU pairing. Therefore, interference between MU pairs determined by the network device is low, and communication quality is good.

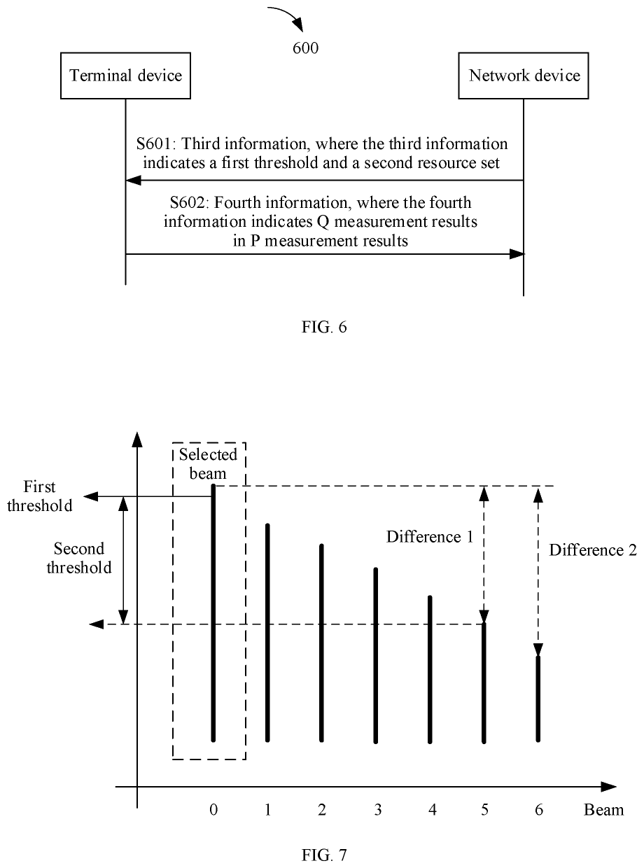

An embodiment of this application further provides a communication method. Refer to FIG. 6. FIG. 6 is a schematic flowchart of a communication method 600 according to an embodiment of this application. In FIG. 6, the method is described from a perspective of interaction between a network device and a terminal device. It should be understood that the communication method 600 may alternatively be implemented by another apparatus, for example, a chip or a communication apparatus that has a communication function. It should be noted that embodiments of this application are merely described by using the network device and the terminal device as an example, and are not limited to the network device and the terminal device. For example, embodiments of this application may alternatively be performed by more terminal devices. When more terminal devices are involved, the more terminal devices perform a same procedure. As shown in FIG. 6, a procedure of the communication method 600 includes the following steps.

S601: The network device sends third information, where the third information indicates a first threshold and a second resource set.

Correspondingly, the terminal device receives the third information. For descriptions of the first threshold, refer to related content in the foregoing communication method 300. Details are not described herein again. The third information may be carried in at least one field in one or more of RRC signaling, DCI, or a MAC CE.

The second resource set is used for interference measurement, or the second resource set is a set including interference resources. For example, the second resource set may be a set including beams that potentially interfere with a serving beam of the terminal device. For ease of description, that the second resource set includes S resources is used as an example. It may be understood that S is an integer greater than or equal to 1. Correspondingly, the terminal device may measure resources in the second resource set, to obtain S measurement results.

In addition, in embodiments of this application, a measurement resource, for example, P measurement resources, may be further configured, where P is an integer greater than or equal to 1. How to indicate the P measurement resources is not limited in embodiments of this application. For example, the P measurement resources belong to a first resource set, and the first resource set may be (pre)configured or predefined. For example, the third information may further indicate the first resource set or the P measurement resources. Alternatively, the network device may send fifth information to the terminal device, where the fifth information may indicate the first resource set or the P measurement resources. When the P measurement resources are some resources in the first resource set, the network device may indicate the first resource set by using the fifth information, and then indicate the P measurement resources in the first resource set by using the third information. The terminal device may measure the P measurement resources to obtain P measurement results, where one measurement resource corresponds to one measurement result.

After measuring the P measurement resources and the S resources in the second resource set, the terminal device may report measurement results to the network device. For example, the terminal device may report Q measurement results in the P measurement results to the network device. A value of Q may be (pre)configured/predefined. The value of Q may be indicated by using the third information, or may be indicated by using the fifth information.

S602: The terminal device sends fourth information, where the fourth information indicates the Q measurement results in the P measurement results.

The terminal device obtains the P measurement results, and may sort the P measurement results in descending order of signal strengths, and determine a measurement result corresponding to a maximum signal strength as a first measurement result. The terminal device may report the first measurement result to the network device, and report Q−1 measurement results other than the first measurement result. For example, the terminal device may send the fourth information to the network device, where the fourth information may indicate the Q measurement results in the P measurement results. In a possible implementation, that the terminal device may send the Q measurement results to the network device based on the first threshold includes the following two cases. For ease of description, the following uses an example in which Q is greater than or equal to 2.

Case A: If the signal strength corresponding to the first measurement result is greater than or equal to the first threshold, the terminal device may report the first measurement result and the Q−1 measurement results other than the first measurement result to the network device. The Q−1 measurement results include the S measurement results corresponding to the S resources. In embodiments of this application, each of the S measurement results may be represented by a difference between the measurement result and the first measurement result. For example, the fourth information may include the first measurement result and S values, and the S values are in a one-to-one correspondence with the S measurement results. For example, an i^{th} value in the S values is a difference between an i^{th} measurement result in the S measurement results and the first measurement result.

The terminal device may report a measurement result with low interference to the network device, to use the measurement result as a candidate resource for multi-beam MU transmission. It may be understood that, if a difference between signal strengths corresponding to measurement results of two resources is large, it may be considered that interference between the two resources is low, or even there is no interference. Therefore, differences between the first measurement result and the measurement results that correspond to the S values and that are reported by the terminal device to the network device are large. For example, the differences may be greater than or equal to a second threshold.

For ease of understanding, FIG. 7 is a diagram of the P measurement results according to an embodiment of this application. In FIG. 7, a beam is used as an example of a resource, and P=7 and Q=3 are used as an example. In a beam 0 to a beam 6 in FIG. 7, RSRP corresponding to the beam 0 is the highest and is greater than the first threshold. Therefore, a measurement result of the beam 0 is the first measurement result. In the beam 1 to the beam 6, a difference between RSRP corresponding to the beam 5 or the beam 6 and the RSRP corresponding to the beam 0 is greater than the second threshold, and a difference between RSRP corresponding to each of the beam 1 to the beam 4 and the RSRP corresponding to the beam 0 is less than the second threshold. Therefore, the terminal device may report measurement results corresponding to the beam 5 and the beam 6. Finally, the terminal device reports, to the network device, the measurement result of the beam 0 (a selected beam as indicated by a dashed line in FIG. 7), and differences between the measurement result of the beam 0 and each of the measurement results of the beam 5 and the beam 6 (a difference 1 and a difference 2 as indicated by dashed lines in FIG. 7).

The terminal device reports the first measurement result and the S values to the network device, and the network device performs multi-beam MU pairing based on the S values. Because an interference resource is considered, the network device may determine, based on the S values, a resource that causes interference to a serving beam, and therefore determine a resource that is not suitable for multi-beam MU transmission. In comparison with a case in which the network device performs MU pairing by using a serving beam of each terminal device as a candidate resource, in this case, interference between a plurality of determined users for MU transmission can be reduced, and communication exceptions can be reduced. In addition, in comparison with a case in which a terminal device reports measurement results of all resources, in this case, a terminal device reports the first measurement result and the S values, so that an amount of data reported by each terminal device can be reduced, and resource overheads can be reduced.

It may be understood that, when S=Q−1, the fourth information includes the first measurement result and the S values, and does not include another measurement result. When S is less than Q−1, in addition to the first measurement result and the S values, the fourth information includes R measurement results, where R=Q−1−S.

Optionally, the R measurement results may be first R measurement results obtained by sorting the P measurement results except the first measurement result in descending order of signal strengths. In other words, in addition to the first measurement result and the S values, the terminal device reports the R measurement results with relatively large signal strengths. The example in FIG. 4 is used. The N measurement results may be the measurement result of the beam 0 and a measurement result of the beam 5. The network device may use a beam corresponding to a second measurement result as a candidate serving beam, to increase an MU pairing probability.

Case B: The signal strength corresponding to the first measurement result is less than or equal to the first threshold, the fourth information includes the Q measurement results, and the Q measurement results are first Q measurement results obtained by sorting the P measurement results in descending order of signal strengths.

When the signal strength corresponding to the first measurement result is less than or equal to the first threshold, the terminal device reports the first Q measurement results obtained by sorting the P measurement results in descending order of signal strengths. The foregoing example in FIG. 5 is still used. It is assumed that P=7, Q=3, and the first measurement result is the measurement result of the beam 0. When the signal strength corresponding to the first measurement result is less than or equal to the first threshold, the terminal device further reports the measurement results of the beam 1 and the beam 2 to the network device, and the terminal device finally reports the measurement results of the beam 0, the beam 1, and the beam 2 to the network device. In Case B, although the signal strength corresponding to the first measurement result is less than or equal to the first threshold, the terminal device still reports the N measurement results including the first measurement result to the network device. The network device may perform multi-beam MU pairing based on the N measurement results.

When the second resource set is invalid, the terminal device reports, by default, the first Q measurement results obtained by sorting the P measurement results in descending order of signal strengths. In other words, the Q measurement results reported by the terminal device are the first Q measurement results obtained by sorting the P measurement results in descending order of signal strengths. In this way, the network device uses resources corresponding to the Q measurement results as candidate service resources, so that relatively good communication quality can be ensured.

That the second resource set is invalid may also be replaced with that the second resource set is invalid or expired. A manner in which the terminal device determines that the second resource set is invalid is not limited in embodiments of this application. For example, in an implementation, the network device may send indication information to the terminal device, where the indication information indicates that the second resource set is invalid. The indication information may be carried in a first indication field in DCI. The first indication field may be an already defined indication field, or may be a newly defined indication field. For example, the first indication field may be a reserved field of the DCI, and indicates whether the second resource set is invalid. Alternatively, the indication information may be carried in RRC signaling, to indicate that the second resource set is invalid.

In the communication method 600, an interference resource is considered. The network device may determine, based on a measurement result of each resource in the second resource set, a resource that is not suitable for multi-beam MU transmission. In comparison with a case in which the network device performs MU pairing by using a serving beam of each terminal device as a candidate resource, in this case, interference between a plurality of determined users for MU transmission can be reduced, and communication exceptions can be reduced. In addition, in comparison with a case in which a terminal device reports measurement results of all resources, in this case, a terminal device reports the first measurement result and the S values, so that an amount of data reported by each terminal device can be reduced, and resource overheads can be reduced. In addition, in comparison with a process of measuring an SINR, in the communication method 600, RRC reconfiguration is not required, and an additional measurement delay can be reduced. In addition, in comparison with the process of measuring the SINR, in this process, the terminal device does not need to support SINR measurement and reporting, and has a low requirement on a processing capability of the terminal device.

A plurality of embodiments in this application may be combined with each other. For example, the communication method 300 and the communication method 600 may be combined with each other. In the foregoing embodiments provided in this application, methods provided in embodiments of this application are described by using an example in which the network device and the terminal device perform the methods. In this application, embodiments may be independently implemented or may be implemented in combination based on some internal relationships. In each embodiment, different implementations may be implemented in combination or independently. To implement functions in the methods provided in embodiments of this application, steps performed by the terminal device may be implemented by different functional entities included in the terminal device. Steps performed by the network device may be implemented by different functional entities included in the network device. For example, the network device may be of a CU-DU architecture, a CU may generate first information, and a DU may send the first information. To implement functions in the methods provided in the foregoing embodiments of this application, the terminal device and the network device may include a hardware structure and/or a software module, and the foregoing functions are implemented in a form of the hardware structure, the software module, or a combination of the hardware structure and the software module. Whether a function in the foregoing functions is performed by using the hardware structure, the software module, or the combination of the hardware structure and the software module depends on particular applications and design constraint conditions of the technical solutions.

Based on a same inventive concept as the method embodiments, an embodiment of this application provides a communication apparatus. The following describes a communication apparatus for implementing the foregoing method in embodiments of this application with reference to the accompanying drawings. All the foregoing content may be used in the following embodiments. Repeated content is not described again.

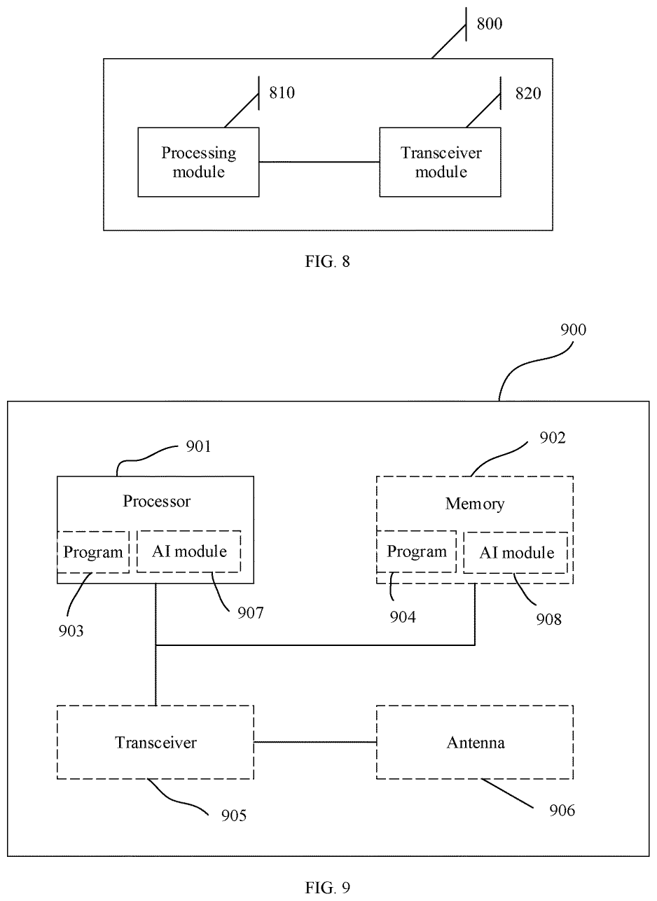

FIG. 8 is a block diagram of a communication apparatus 800 according to an embodiment of this application. The communication apparatus 800 may be the terminal device or the network device in the foregoing embodiments. For example, the communication apparatus 800 may be the terminal device in FIG. 1; or the communication apparatus 800 is a chip (system) in the terminal device; or the communication apparatus 800 is a software module in the terminal device. The communication apparatus 800 may correspondingly implement functions or steps implemented by the terminal device in the foregoing method embodiments. For another example, the communication apparatus 800 may be the network device in FIG. 1; or the communication apparatus 800 is a chip (system) in the network device; or the communication apparatus 800 is a software module in the network device. The communication apparatus 800 may correspondingly implement functions or steps implemented by the network device in the foregoing method embodiments. The communication apparatus 800 may include a processing module 810 and a transceiver module 820. Optionally, a storage module may be further included. The storage module may be configured to store instructions (code or a program) and/or data. The storage module may be, for example, a memory. The processing module 810 and the transceiver module 820 may be coupled to the storage module. For example, the processing module 810 may read the instructions (the code or the program) and/or the data in the storage module, to implement a corresponding method. When the communication apparatus 800 is the chip in the terminal device or the network device, the storage module may be a storage module in the chip, for example, a register or a cache. For example, the storage module may alternatively be a storage module that is in the terminal device or the network device and that is located outside the chip, for example, a read-only memory (ROM), another type of static storage device that can store static information and instructions, or a random access memory (RAM). The foregoing units may be independently disposed, or may be partially or completely integrated.

The processing module 810 may be a processor or a controller, for example, may be a general-purpose central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processing module may implement or execute various example logical blocks, modules, and circuits described with reference to content disclosed in this application. Alternatively, the processor may be a combination of processors implementing a computing function, for example, a combination of one or more microprocessors, or a combination of a DSP and a microprocessor. The transceiver module 820 is a transceiver, an interface circuit, a bus, a pin, or another possible communication interface, and is configured to receive a signal from another apparatus. For example, when the apparatus is implemented in a form of a chip, the transceiver module 820 is an interface circuit used by the chip to receive a signal from another chip or apparatus, or is an interface circuit used by the chip to send a signal to another chip or apparatus.

In an implementation, the communication apparatus 800 can correspondingly implement behaviors and functions of the terminal device in the foregoing method embodiments. The communication apparatus 800 may be a terminal device, may be a component (for example, a chip or a circuit) used in the terminal device, may be a chip or a chip group in the terminal device or a part that is of the chip and that is configured to perform a related method function, or may be a software module that can implement the method performed by the terminal device in the foregoing method (for example, the communication method 300 or the communication method 600). This is not limited. For details, refer to the related content in the foregoing method embodiments. Details are not described herein again.

In an example 1, the transceiver module 820 is configured to: receive first information, and send N measurement results in M measurement results. The processing module 810 is configured to determine the N measurement results in the M measurement results. The first information indicates a first threshold and a second threshold. The M measurement results are results obtained by measuring reference signals received through M measurement resources, and one measurement resource corresponds to one reference signal. The N measurement results include a first measurement result, and the first measurement result has a maximum signal strength among the M measurement results. Both M and N are integers greater than 1. The signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold.

In an optional implementation, the N measurement results are the first measurement result and a second measurement result. The second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold.

In an optional implementation, the first information further indicates one or more of the following: the M measurement resources, a value of N, or a first resource set, where the first resource set includes the M measurement resources.

In an optional implementation, the transceiver module 820 is further configured to receive second information, where the second information indicates a first resource set and/or a value of N, and the first resource set includes the M measurement resources.

In an example 2, the transceiver module 820 is configured to: receive first information, and send N measurement results in M measurement results. The processing module 810 is configured to determine the N measurement results in the M measurement results. The first information indicates a first threshold and a second threshold. The M measurement results are results obtained by measuring reference signals received through M measurement resources, and one measurement resource corresponds to one reference signal. The N measurement results include a first measurement result. A signal strength corresponding to the first measurement result is less than or equal to the first threshold, and the N measurement results are first N measurement results obtained by sorting the M measurement results in descending order of signal strengths. Both M and N are integers greater than 1.

In an optional implementation, the first information further indicates one or more of the following: the M measurement resources, a value of N, or a first resource set, where the first resource set includes the M measurement resources.

In an optional implementation, the transceiver module 820 is further configured to receive second information, where the second information indicates a first resource set and/or a value of N, and the first resource set includes the M measurement resources.

In an example 3, the transceiver module 820 is configured to: receive third information, and send fourth information. The processing module 810 is configured to determine the fourth information. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is greater than or equal to the first threshold, the fourth information includes S values, an i^{th} value in the S values is a difference between an i^{th} measurement result in S measurement results and the first measurement result, and the S measurement results belong to the Q measurement results.

In an optional implementation, S is less than Q−1, the Q measurement results further include R measurement results, and R is a difference between Q−1 and S.

In an optional implementation, the R measurement results are first R measurement results obtained by sorting the P measurement results except the first measurement result in descending order of signal strengths.

In an optional implementation, when the second resource set is invalid, the Q measurement results are first Q measurement results obtained by sorting the P measurement results in descending order of signal strengths.

In an optional implementation, the third information further indicates one or more of the following: the P measurement resources, a value of Q, or a first resource set, where the first resource set includes the P measurement resources.

In an optional implementation, the transceiver module 820 is further configured to receive fifth information, where the fifth information indicates a first resource set and/or a value of Q, and the first resource set includes the P measurement resources.

In an example 4, the transceiver module 820 is configured to: receive third information, and send fourth information. The processing module 810 is configured to determine the fourth information. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is less than or equal to the first threshold, the fourth information includes the Q measurement results, and the Q measurement results are first Q measurement results obtained by sorting the P measurement results in descending order of signal strengths.

In an optional implementation, the third information further indicates one or more of the following: the P measurement resources, a value of Q, or a first resource set, where the first resource set includes the P measurement resources.

In an optional implementation, the transceiver module 820 is further configured to receive fifth information, where the fifth information indicates a first resource set and/or a value of Q, and the first resource set includes the P measurement resources.

In an implementation, the communication apparatus 800 can correspondingly implement behaviors and functions of the network device in the foregoing method embodiments. The communication apparatus 800 may be a network device, may be a component (for example, a chip or a circuit) used in the network device, may be a chip or a chip group in the network device or a part that is of the chip and that is configured to perform a related method function, or may be a software module that can implement the method performed by the network device in the foregoing method (for example, the communication method 300 or the communication method 600). This is not limited. For details, refer to the related content in the foregoing method embodiments. Details are not described herein again.

In an example 1, the transceiver module 820 is configured to: send first information, and receive N measurement results in M measurement results. The processing module 810 is configured to determine the first information. The first information indicates a first threshold and a second threshold. The M measurement results are results obtained by measuring reference signals received through M measurement resources, and one measurement resource corresponds to one reference signal. The N measurement results include a first measurement result, and the first measurement result has a maximum signal strength among the M measurement results. Both M and N are integers greater than 1. The signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold.

In an optional implementation, the N measurement results are the first measurement result and a second measurement result. The second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold.

In an optional implementation, the first information further indicates one or more of the following: the M measurement resources, a value of N, or a first resource set, where the first resource set includes the M measurement resources.

In an optional implementation, the transceiver module 820 is further configured to send second information, where the second information indicates a first resource set and/or a value of N, and the first resource set includes the M measurement resources.

In an example 2, the transceiver module 820 is configured to: send first information, and receive N measurement results in M measurement results. The processing module 810 is configured to determine the first information. The first information indicates a first threshold and a second threshold. The M measurement results are results obtained by measuring reference signals received through M measurement resources, and one measurement resource corresponds to one reference signal. The N measurement results include a first measurement result. A signal strength corresponding to the first measurement result is less than or equal to the first threshold, and the N measurement results are first N measurement results obtained by sorting the M measurement results in descending order of signal strengths. Both M and N are integers greater than 1.

In an optional implementation, the first information further indicates one or more of the following: the M measurement resources, a value of N, or a first resource set, where the first resource set includes the M measurement resources.

In an optional implementation, the transceiver module 820 is further configured to receive second information, where the second information indicates a first resource set and/or a value of N, and the first resource set includes the M measurement resources.

In an example 3, the transceiver module 820 is configured to: send third information, and receive fourth information. The processing module 810 is configured to determine the third information. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is greater than or equal to the first threshold, the fourth information includes S values, an i^{th} value in the S values is a difference between an i^{th} measurement result in S measurement results and the first measurement result, and the S measurement results belong to the Q measurement results.

In an optional implementation, S is less than Q−1, the Q measurement results further include R measurement results, and R is a difference between Q−1 and S.

In an optional implementation, the R measurement results are first R measurement results obtained by sorting the P measurement results except the first measurement result in descending order of signal strengths.

In an optional implementation, when the second resource set is invalid, the Q measurement results are first Q measurement results obtained by sorting the P measurement results in descending order of signal strengths.

In an optional implementation, the third information further indicates one or more of the following: the P measurement resources, a value of Q, or a first resource set, where the first resource set includes the P measurement resources.

In an optional implementation, the transceiver module 820 is further configured to send fifth information, where the fifth information indicates a first resource set and/or a value of Q, and the first resource set includes the P measurement resources.

In an example 4, the transceiver module 820 is configured to: send third information, and receive fourth information. The processing module 810 is configured to determine the third information. The third information indicates a first threshold and a second resource set, the second resource set includes S resources for interference measurement, and S is an integer greater than or equal to 1. The fourth information indicates Q measurement results in P measurement results, where the P measurement results are results obtained by measuring reference signals received through P measurement resources, and one measurement resource corresponds to one reference signal. The Q measurement results include a first measurement result, where the first measurement result has a maximum signal strength among the P measurement results, and both P and Q are integers greater than 1. The signal strength corresponding to the first measurement result is less than or equal to the first threshold, the fourth information includes the Q measurement results, and the Q measurement results are first Q measurement results obtained by sorting the P measurement results in descending order of signal strengths.

In an optional implementation, the third information further indicates one or more of the following: the P measurement resources, a value of Q, or a first resource set, where the first resource set includes the P measurement resources.

In an optional implementation, the transceiver module 820 is further configured to send fifth information, where the fifth information indicates a first resource set and/or a value of Q, and the first resource set includes the P measurement resources.

When the communication apparatus 800 is a chip-type apparatus or circuit, the transceiver module may be an input/output circuit and/or a communication interface, and the processing module is an integrated processor, a microprocessor, or an integrated circuit.

FIG. 9 is a block diagram of a communication apparatus 900 according to an embodiment of this application. The communication apparatus 900 may be the terminal device or the network device in the foregoing embodiments. For example, the communication apparatus 900 may be the terminal device in FIG. 1 or a chip (system) in the terminal device. In embodiments of this application, the chip system may include a chip, or may include a chip and another discrete component. For specific functions, refer to the descriptions in the foregoing method embodiments. For another example, the communication apparatus 900 may be the network device in FIG. 1 or a chip (system) in the network device. In embodiments of this application, the chip system may include a chip, or may include a chip and another discrete component. For specific functions, refer to the descriptions in the foregoing method embodiments.

The communication apparatus 900 includes one or more processors 901, configured to implement or support the communication apparatus 900 in implementing the function of the terminal device or the network device in the methods provided in embodiments of this application. For details, refer to detailed descriptions in the method example. Details are not described herein again. The processor 901 may also be referred to as a processing unit or a processing module, and may implement a specific control function. The processor 901 may be a general-purpose processor, a special-purpose processor, or the like. For example, the processor includes a baseband processor, a central processing unit, an application processor, a modem processor, a graphics processing unit, an image signal processor, a digital signal processor, a video codec processor, a controller, a memory, and/or a neural network processor. The baseband processor may be configured to process a communication protocol and communication data. The central processing unit may be configured to: control the communication apparatus 900 (for example, the network device or the terminal device), execute a software program, and/or process data. Different processors may be independent components, or may be integrated into one or more processors, for example, integrated into one or more application-specific integrated circuits.

In a design, the processor 901 may include a program 903 (which may sometimes also be referred to as code or instructions). The program 903 may be run on the processor 901, to enable the communication apparatus 900 to perform the method described in the following embodiments. In another possible design, the communication apparatus 900 includes a circuit (not shown in FIG. 9), and the circuit is configured to implement the function of the terminal device or the network device in the foregoing embodiments.

In a design, the communication apparatus 900 may include one or more memories 902 storing a program 904 (which may sometimes also be referred to as code or instructions), and the program 904 may be run on the processor 901, to enable the communication apparatus 900 to perform the method described in the foregoing method embodiments, for example, the procedure shown in FIG. 3.

In a design, the processor 901 and/or the memory 902 may include an artificial intelligence (AI) module 907 and an AI module 908. The AI module is configured to implement an AI-related function. The AI module may be implemented by using software, hardware, or a combination of software and hardware. For example, the AI module may include a RAN intelligent controller (RIC) module. For example, the AI module may be a near-real-time RIC or a non-real-time RIC.

In a possible design, the processor 901 and/or the memory 902 may further store data. The processor and the memory may be separately disposed, or may be integrated together.

In a possible design, the communication apparatus 900 may further include a transceiver 905 and/or an antenna 906. The processor 901 may sometimes also be referred to as a processing unit, and controls the communication apparatus 900. The transceiver 905 may sometimes also be referred to as a transceiver unit, a transceiver machine, a transceiver circuit, a transceiver device, or the like, and is configured to implement a transceiver function of the communication apparatus 900 through the antenna 906.

In a possible design, the communication apparatus 900 may further include one or more of the following components: a wireless communication module, an audio module, an interface for external memory, an internal memory, a universal serial bus (USB) interface, a power management module, an antenna, a speaker, a microphone, an input/output module, a sensor module, a motor, a camera, a display, or the like. It may be understood that in some embodiments, the communication apparatus 900 may include more or fewer components, some components are integrated, or some components are split. The components may be implemented by hardware, software, or a combination of software and hardware.

The communication apparatus in the foregoing embodiments may be a terminal device, or may be a circuit, or may be a chip used in a terminal device, or may be another combined component or part having the terminal device, or the like. Alternatively, the communication apparatus in the foregoing embodiments may be a network device, or may be a circuit, or may be a chip used in a network device, or may be another combined component or part having the network device, or the like. When the communication apparatus is a terminal device or a network device, the transceiver module may be a transceiver, and may include an antenna, a radio frequency circuit, and the like, and the processing module may be a processor, for example, a CPU. When the communication apparatus is a chip system, the communication apparatus may be an FPGA, a dedicated ASIC, a system on chip (SoC), a CPU, a network processor (NP), a DSP, a micro controller unit (MCU), a programmable controller (PLD), or another integrated chip. The processing module may be a processor of the chip system. The transceiver module or a communication interface may be an input/output interface or an interface circuit of the chip system. For example, the interface circuit may be a code/data read/write interface circuit. The interface circuit may be configured to receive code instructions (where the code instructions are stored in the memory, and may be directly read from the memory, or may be read from the memory through another device) and transmit the code instructions to the processor. The processor may be configured to run the code instructions to perform the method in the foregoing method embodiments. For another example, the interface circuit may alternatively be a signal transmission interface circuit between a communication processor and the transceiver machine.

An embodiment of this application further provides a communication system. Specifically, the communication system includes at least one terminal device and at least one network device. The terminal device is a terminal device configured to implement functions related to the communication method 300 and/or the communication method 600, and the network device is a network device configured to implement functions related to the communication method 300 and/or the communication method 600. For details, refer to related descriptions in the foregoing method embodiments. Details are not described herein again.

An embodiment of this application further provides a computer-readable storage medium, including instructions. When the instructions are run on a computer, the computer is enabled to perform the method performed by the terminal device or the network device in the communication method 300 and/or the communication method 600.

An embodiment of this application further provides a computer program product, including computer program code. When the computer program code is executed, a computer is enabled to perform the method performed by the terminal device or the network device in the communication method 300 and/or the communication method 600.

An embodiment of this application provides a chip system. The chip system includes a processor, and may further include a memory, and is configured to implement functions of the terminal device or the network device in the method 300 and/or the communication method 600. The chip system may include a chip, or may include a chip and another discrete component.

To implement the functions of the communication apparatuses in FIG. 8 and FIG. 9, an embodiment of this application further provides a chip, including a processor, configured to support the communication apparatus in implementing the functions of the terminal device or the network device in the foregoing method embodiments. In a possible design, the chip is connected to a memory, or the chip includes a memory. The memory is configured to store a computer program or instructions and data that are necessary for the communication apparatus.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with various illustrative logical blocks (illustrative logical blocks) described in embodiments disclosed in this specification and steps (steps) may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division. There may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separated, and parts displayed as units may or may not be physical units, may be located in one position, or may be distributed on a plurality of network units. Some or all of the units may be selected based on actual requirements to achieve the objectives of the solutions of embodiments.

When the functions are implemented in a form of a software functional unit and sold or used as an independent product, the functions may be stored in a computer-readable storage medium. Based on such an understanding, the technical solutions of this application essentially, the contributing part, or some of the technical solutions may be embodied in a form of a software product. The computer software product is stored in a storage medium, and includes several instructions for enabling a computer device (which may be a personal computer, a server, a network device, or the like) to perform all or some steps of the methods in embodiments of this application. The foregoing storage medium includes any medium that can store program code, such as a USB flash drive, a removable hard disk, a ROM, a RAM, a magnetic disk, or an optical disc.

It is clearly that, a person skilled in the art can make various modifications and variations to this application without departing from the scope of this application. In this way, this application is intended to cover these modifications and variations of this application provided that they fall within the scope of the claims of this application and their equivalent technologies.

What is claimed is:

1. A communication method, comprising:
receiving first information, wherein the first information indicates a first threshold and a second threshold; and
sending N measurement results in M measurement results, wherein the N measurement results comprise a first measurement result, the first measurement result has a maximum signal strength among the M measurement results, the M measurement results are results obtained by measuring reference signals received through M measurement resources, one measurement resource corresponds to one reference signal, and both M and N are integers greater than 1; and
the signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold.

2. The method according to claim 1, wherein the N measurement results are the first measurement result and a second measurement result, the second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold.

3. The method according to claim 1, wherein the first information further indicates one or more of the following:
the M measurement resources;
a value of N; or
a first resource set, wherein the first resource set comprises the M measurement resources.

4. The method according to claim 1, wherein the method further comprises:
receiving second information, wherein the second information indicates a first resource set and/or a value of N, and the first resource set comprises the M measurement resources.

5. A communication method, comprising:
sending first information, wherein the first information indicates a first threshold and a second threshold; and
receiving N measurement results, wherein the N measurement results belong to M measurement results, the M measurement results are results obtained by measuring reference signals received through M measurement resources, one measurement resource corresponds to one reference signal, and both M and N are integers greater than 1; and
the N measurement results comprise a first measurement result, the first measurement result has a maximum signal strength among the M measurement results, the signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold.

6. The method according to claim 5, wherein the N measurement results are the first measurement result and a second measurement result, the second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold.

7. The method according to claim 5, wherein the first information further indicates one or more of the following:
the M measurement resources;
a value of N; or
a first resource set, wherein the first resource set comprises the M measurement resources.

8. The method according to claim 5, wherein the method further comprises:
sending second information, wherein the second information indicates a first resource set and/or a value of N, and the first resource set comprises the M measurement resources.

9. A communication apparatus, comprising at least one processor, wherein the at least one processor is coupled to a memory storing programming instructions for execution by the at least one processor, to enable the communication apparatus to:
send first information, and receive N measurement results, wherein the first information indicates a first threshold and a second threshold, the N measurement results belong to M measurement results, the M measurement results are results obtained by measuring reference signals received through M measurement resources, one measurement resource corresponds to one reference signal, and both M and N are integers greater than 1; and the N measurement results comprise a first measurement result, the first measurement result has a maximum signal strength among the M measurement results, the signal strength corresponding to the first measurement result is greater than or equal to the first threshold, and a difference between a signal strength corresponding to each of remaining N−1 measurement results in the N measurement results and the signal strength corresponding to the first measurement result is greater than or equal to the second threshold; and
determine the first information.

10. The apparatus according to claim 9, wherein the N measurement results are the first measurement result and a second measurement result, the second measurement result is a measurement result in which a signal strength is the maximum among T measurement results, the T measurement results belong to the M measurement results, and a difference between a signal strength corresponding to each of the T measurement results and the signal strength corresponding to the first measurement result is greater than or equal to the second threshold.

11. The apparatus according to claim 9, wherein the first information further indicates one or more of the following:
the M measurement resources;
a value of N; or
a first resource set, wherein the first resource set comprises the M measurement resources.

12. The apparatus according to claim 9, wherein the apparatus is further configured to:
send second information, wherein the second information indicates a first resource set and/or a value of N, and the first resource set comprises the M measurement resources.
